(19) United States
(12) Patent Application Publication
(10) Pub. No.: US 2008/0288674 A1
(43) Pub. Date: Nov. 20, 2008

(54) Storage system and storage device

(75) Inventors: Seiji Suzuki, Kanagawa (JP); Kunihiro Seno, Kyoto (JP); Takeshi Kamimura, Kanagawa (JP); Nobuo Mori, Kanagawa (JP); Junji Okada, Kanagawa (JP); Norihiko Kuroishi, Kanagawa (JP); Manabu Akamatsu, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/999,128

(22) Filed: Dec. 4, 2007

(30) Foreign Application Priority Data
May 14, 2007 (JP) P2007-128326

(51) Int. Cl. G06F 13/00

(52) U.S. Cl. 710/56

(57) ABSTRACT

A storage system includes: a plurality of data input and output parts through; a data storing part that stores the data inputted and outputted through the plurality of data input and output parts; a range information storing part that stores range information; first control part controlling the data storing part to read and write the data in accordance with the stored range information, and that rewrites the stored range information to predetermined range information in a case where a prescribed signal is inputted from the data input and output part; and a plurality of second control parts that are provided correspondingly to the plurality of data input and output parts to input and output the data, and that input the prescribed signal to the data input and output parts in a prescribed case.

### CROSS-REFERENCE TO RELATED APPLICATIONS

This application is based on and claims priority under 35 U.S.C. 119 from Japanese Patent Application No. 2007-128326 filed May 14, 2007.

### BACKGROUND

1. Technical Field

The present invention relates to a storage system and a storage device.

2. Related Art

Usually, a technique is proposed that a semiconductor disk device is connected to a host computer (abbreviate it as a host, hereinafter) to back up data stored in the semiconductor disk device.

### SUMMARY

According to an aspect of the present invention, a storage system comprising: a plurality of data input and output parts through which data is inputted and outputted; a data storing part that stores the data inputted and outputted through the plurality of data input and output parts; a range information storing part that stores range information showing ranges of a storing area of the data storing part which are respectively allocated to the plurality of data input and output parts; a first control part controlling the data storing part to read and write the data in accordance with the range information stored in the range information storing part, and that rewrites the range information stored by the range information storing part to predetermined range information in a case where a prescribed signal is inputted from the data input and output part; and a plurality of second control parts that are provided correspondingly to the plurality of data input and output parts to input and output the data between the plurality of data input and output parts and the second control parts, and that input the prescribed signal to the data input and output parts in a prescribed case.

### BRIEF DESCRIPTION OF THE DRAWINGS

Exemplary embodiment of the present invention will be described in detail based on the following figures, wherein:

FIG. 1 is a block diagram showing a schematic structural example of a storage system according to a first embodiment of the present invention;

FIG. 2 is a block diagram showing a schematic structural example of a storage system according to a second embodiment of the present invention;

FIGS. 3A to 3B show one example of the range information and the storing area of the storage system according to the second embodiment, FIG. 3A is a diagram showing that the storing area is divided into two parts, FIG. 3B is a diagram showing that an unused area (blank) is provided in the storing area and FIG. 3C is a diagram showing that a duplicated storing area is provided, respectively;

FIG. 4A and 4B show one example of the range information and the storing area of the storage system according to the second embodiment, FIG. 4A is a diagram showing that the storage system normally operates and FIG. 4B is a diagram showing that the storing areas are exchanged, respectively;

FIG. 5 is a diagram showing one example of an area setting screen displayed on the display parts of first and second hosts according to a third embodiment of the present invention;

FIG. 6 is a block diagram showing a schematic structural example of a storage system according to a fourth embodiment of the present invention;

FIG. 7 is a block diagram showing a schematic structural example of a storage system according to a fifth embodiment of the present invention;

FIG. 8A to 8C show one example of the range information and the storing area of the storage system according to the fifth embodiment, FIG. 8A is a diagram showing range information, FIG. 8B is a diagram showing a storing area and FIG. 8C is a diagram showing the storing area viewed in the form of a ring, respectively;

FIGS. 9A to 9C show one example of the range information and the storing area of the storage system according to the fifth embodiment, FIG. 9A is a diagram showing rewritten range information, FIG. 9B is a diagram showing a storing area and FIG. 9C is a diagram showing the storing area viewed in the form of a ring, respectively;

FIG. 10 is a flowchart showing one example of an operation of the storage system according to the fifth embodiment;

FIG. 11 is a block diagram showing a schematic structural example of a storage system according to a sixth embodiment of the present invention;

FIG. 12A to 12C show one example of the range information and the storing area of the storage system according to the sixth embodiment of the present invention, FIG. 12A is a diagram showing range information, FIG. 12B is a diagram showing a storing area and FIG. 12C is a diagram showing the storing area viewed in the form of a ring, respectively;

FIGS. 13A to 13B show one example of the range information and the storing area of the storage system according to the sixth embodiment of the present invention, FIG. 13A is a diagram showing rewritten range information, FIG. 13B is a diagram showing a storing area and FIG. 13C is a diagram showing the storing area viewed in the form of a ring, respectively;

FIG. 14 is a block diagram showing a schematic structural example of a storage system according to a seventh embodiment of the present invention;

FIGS. 15A to 15C show one example of the range information and the storing area of the storage system according to the seventh embodiment of the present invention, FIG. 15A is a diagram showing range information, FIG. 15B is a diagram showing a storing area and FIG. 15C is a diagram showing the storing area viewed in the form of a ring, respectively;

FIGS. 16A to 16C show one example of the range information and the storing area of the storage system according to the seventh embodiment of the present invention, FIG. 16A is a diagram showing rewritten range information, FIG. 16B is a diagram showing a storing area and FIG. 16C is a diagram showing the storing area viewed in the form of a ring, respectively;

FIG. 17 is a block diagram showing a schematic structural example of a storage system according to an eighth embodiment of the present invention; and

FIG. 18 is a diagram showing the range information and the storing area of the storage system according to the eighth embodiment of the present invention.

### DETAILED DESCRIPTION

### First Embodiment

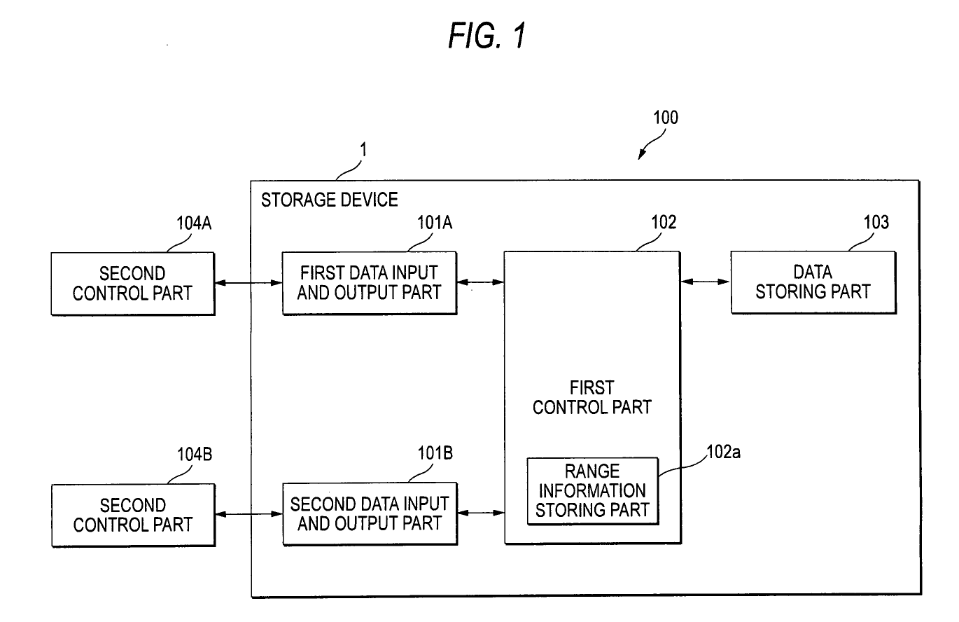

FIG. 1 is a block diagram showing a schematic structural example of a storage system according to a first embodiment of the present invention. This storage system 100 includes a storage device 1 for storing data and second control parts 104A and 104B for reading and writing the data stored in the storage device 1. The number of the second control parts is not limited to two and may be three or more.

The storage device 1 includes first and second data input and output parts 101A and 101B, a data storing part 103 for storing the data inputted and outputted through the first and second data input and output parts 101A and 101B and a first control part 102 for controlling the data storing part 103 to read and write the data.

The first and second data input and output parts 101A and 101B are respectively connected to the second control parts 104A and 104B to input and output the data in accordance with, for instance, an interface standard such as PCI Express (a registered trademark).

A range information storing part 102a provided in the first control part 102 is a storing part for storing internal information managed by the first control part 102. In the range information storing part 102a, range information showing the ranges of a storing area composed of the data storing part 103 is stored that are respectively allocated to the first and second data input and output parts 101A and 101B.

The first control part 102 is provided with a circuit for controlling a memory to treat the storing area as one common memory space. Further, the first control part 102 includes a circuit for controlling the data storing part 103 to read and write the data in accordance with the range information stored in the range information storing part 102a.

Further, the first control part 102 rewrites the range information stored in the range information storing part 102a to predetermined range information when a below-described prescribed signal is inputted from the first and second data input and output parts 101A and 101B.

The data storing part is composed of a volatile semiconductor memory such as a DRAM or a non-volatile semiconductor memory such as a flash memory. The data storing part may be composed of a plurality of semiconductor memories or composed of a magnetic disk device. Further, the data storing part may be composed of the semiconductor memory combined with the magnetic disk device and is not limited to them.

The second control parts 104A and 104B are provided correspondingly to the first and second data input and output parts 101A and 101B to input and output the data between the first and second data input and output parts 101A and 101B and the second control parts 104A and 104B and input the prescribed signal to the first and second data input and output parts 101A and 101B in a prescribed case.

Here, the prescribed case means, for instance, a case that the second control parts 104A and 104B detect a failure in inputting and outputting the data between the first and second data input and output parts 101A and 101B and the second control parts 104A and 104B or a case that the data is inputted and outputted relative to a plurality of divided storing areas obtained by dividing the storing area into a plurality of parts and is not limited to these cases.

Further, for instance, when the second control parts 104A and 104B detect the failure in inputting and outputting the data between the first and second data input and output parts 101A and 101B and the second control parts 104A and 104B, a failure informing signal is inputted as the prescribed signal to the first and second data input and output parts 101A and 101B. The prescribed signal may be a timing signal for controlling a first-in and first-out of the data relative to the divided storing areas, a data set signal for instructing all the storing areas to input and output the data and a shift signal for instructing the divided storing areas to input and output divided data obtained by dividing the data into a plurality of parts, and is not limited to these signals.

In the above-described structure, when the prescribed signal sent from the one second control part 104A is inputted to the first control part 102 through the first data input and output part 101A, the first control part 102 rewrites the range information stored by the range information storing part to the predetermined range information.

### Second Embodiment

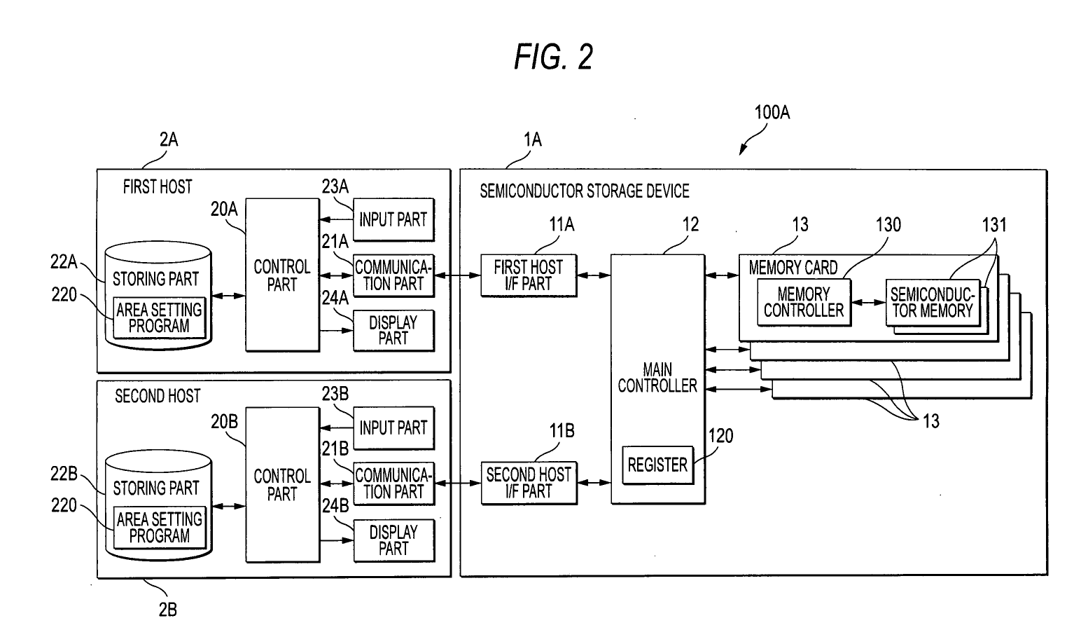

FIG. 2 is a block diagram showing a schematic structural example of a storage system according to a second embodiment of the present invention. This storage system 100A includes a semiconductor storage device 1A for storing data and first and second hosts 2A and 2B for reading and writing the data stored in the semiconductor storage device 1A. The number of the hosts is not limited to two and may be three or more.

### (Structure of Host)

The first and second hosts 2A and 2B respectively include control parts (second control parts) 20A and 20B composed of CPUs for controlling the respective parts of the hosts, communication parts 21A and 21B for inputting and outputting data, storing parts 22A and 22B in which an area setting programs 220 are stored, input parts 23A and 23B composed of a keyboard and a mouse and display parts 24A and 24B composed of an LCD (a liquid crystal display) for displaying various kinds of screens. The above-described first and second hosts 2A and 2B are formed with, for instance, a server, a personal computer (PC), a work station (WS) or the like.

The control parts 20A and 20B operate in accordance with the area setting programs 220 to respectively function as a failure detecting unit for detecting a failure in inputting and outputting the data relative to the semiconductor storage device 1A and a failure informing unit for informing of the failure detected by the failure detecting unit by a failure informing signal through the communication parts 21A and 21B.

### (Structure of Semiconductor Storage Device)

The semiconductor storage device 1A includes first and second host interface parts (data input and output parts, abbreviate them as host I/F parts, hereinafter.) 11A and 11B through which the data is inputted and outputted, a main controller (a first control part) 12 for controlling the data inputted and outputted through the first and second host I/F parts 11A and 11B to be read and written and a plurality of memory cards (data storing parts) 13 for storing the data transmitted from the main controller 12.

The plurality of memory cards 13 include memory controllers 130 and semiconductor memories 131.

The memory controller 130 serially transmits the data between the main controller 12 and the memory controller 13. During writing the data, the memory controller writes the data transmitted from the main controller 12 in a designated address of the semiconductor memory 131. During reading the data, the memory controller 130 reads the data from the designated address of the semiconductor memory 131 and supplies the read data to the main controller 12.

A register (a range information storing part) 120 is a storing part provided in the main controller 12. In the register 120, range information is stored that shows the ranges of storing areas of a storing area composed of the plurality of memory cards 13 respectively allocated to the first and second host I/F parts 11A and 11B.

The main controller 12 includes a circuit for managing a memory to treat the storing area composed of the plurality of memory cards 13 as one common memory space and a circuit for controlling to read and write the data in the memory cards 13 in accordance with the range information stored in the register 120. Other parts of the main controller 12 are formed in the same way as that of the first control part 102 according to the first embodiment.

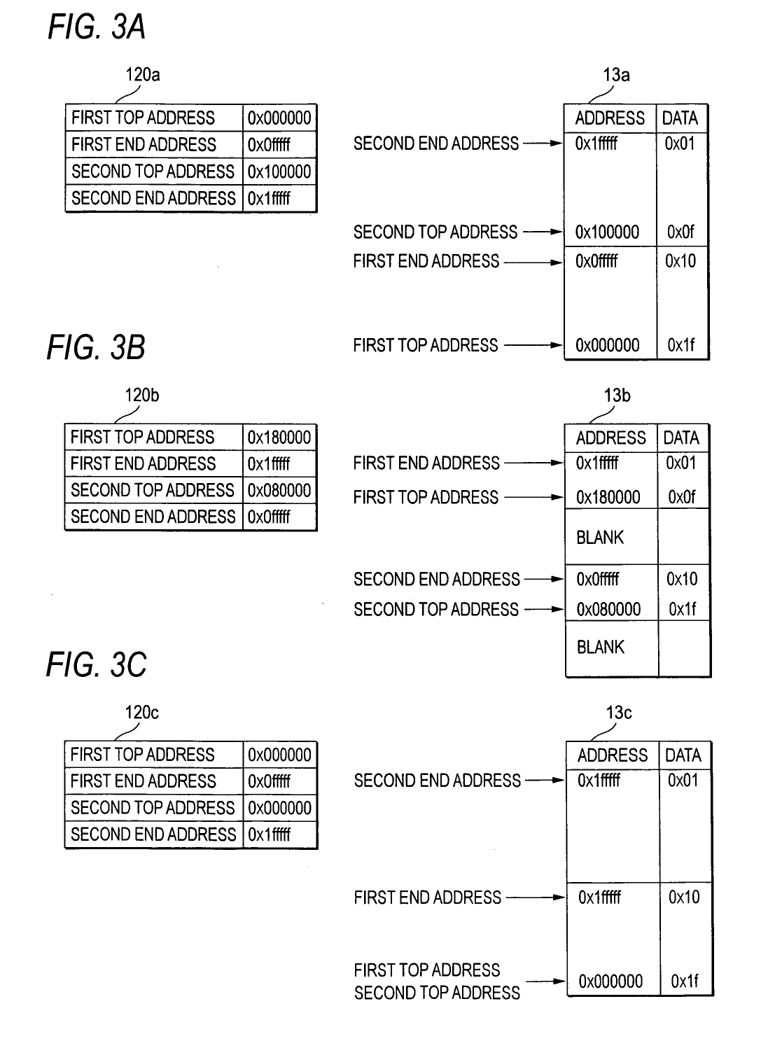

FIG. 3 is a diagram showing one example of the range information stored in the register 120 and storing areas allocated to the first and second host I/F parts 11A and 11B in accordance with the range information. In the range information 120a to 120c, the first top address and the last address respectively show the first and last addresses of the storing area allocated to the first host I/F part 11A. Further, the second top address and the last address similarly show the first and last addresses of the storing area allocated to the second host I/F part 11B.

Further, storing areas 13a to 13c show the storing areas composed of the plurality of memory cards 13 to store the data of one byte or one word respectively in the addresses of “0x000000” to “0x1fffff”. A record unit of the data is not limited to one byte or one word, and may be, for instance, a block unit including 512 bytes as one block and is not limited thereto. Further, the storing areas 13a to 13c may have an arbitrary storage capacity. The storage capacity may be changed depending on the storage capacity of the semiconductor memory 131 or the number of the memory cards 13.

FIG. 3A shows one example of the range information 120a obtained when the storing area 13a is divided into two. That is, to the first host I/F part 11A, the storing area of the addresses “0x000000” to “0x0fffff” is allocated. To the second host I/F part 11B, the storing area of addresses “0x100000” to “0x1fffff” is allocated.

FIG. 3B shows one example of the range information 120b obtained when an unused area (blank) is provided between the storing areas allocated to the first and second host I/F parts 11A and 11B. That is, to the first host I/F part 11A, the storing area of addresses “0x180000” to “0x1fffff” is allocated. To the second host I/F part 11B, the storing area of addresses “0x080000” to “0x0fffff” is allocated. Then, in the storing area 13b, an unused area of addresses “0x000000” to “0x07ffff” and an unused area of addresses “0x100000” to “0x17ffff” are provided.

FIG. 3C shows one example of the range information 120c obtained when the duplicated storing areas are allocated to the first and second host I/F parts 11A and 11B. That is, to the first host I/F part 11A, the storing area of addresses “0x000000” to “0x0fffff” is allocated. To the second host I/F part 11B, the storing area of addresses “0x000000” to “0x1fffff” is allocated. Then, the storing area of the addresses “0x000000” to “0x0fffff” corresponds the duplicated storing area in which the data can be inputted and outputted from both the first and second host I/F parts 11A and 11B.

In the range information, the storing area allocated to the first host I/F part 11A may be partly duplicated on the storing area allocated to the second d host I/F part 11B, or either storing area may include the other storing area.

### (Operation of Second Embodiment)

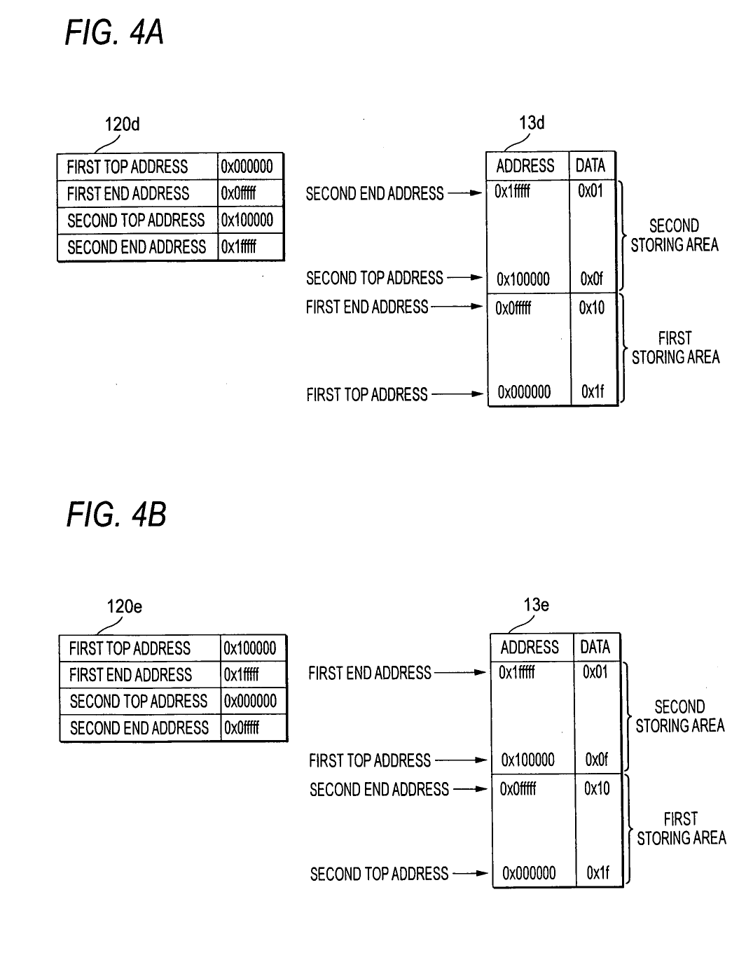

Now, one example of an operation of the storage system 100A according to the second embodiment will be described by referring to FIG. 4. FIG. 4A shows one example of the range information obtained when the storage system 100A normally operates. In accordance with range information 120d, to the first host I/F part 11A, a first storing area of the addresses “0x000000” to “0x0fffff” is allocated. To the second host I/F part 11B, a second storing area of addresses “0x100000” to “0x1fffff” is allocated. Accordingly, the first host 2A inputs and outputs the data to the first storing area through the first host I/F 11A, and the second host 2B inputs and outputs the data to the second storing area through the second host I/F part 11B.

Here, if a failure is generated in the first host 2A, a failure detecting unit of the first host 2A detects the failure. Then, when the failure detecting unit transmits information that the failure detecting unit detects the failure to a failure informing unit, the failure informing unit transmits a failure informing signal to the semiconductor storage device 1A through the communication part 21A.

Then, when the first host I/F part 11A of the semiconductor storage device 1A receives the failure informing signal, the first host I/F part 11A transmits the failure informing signal to the main controller 12.

Then, when the main controller 12 receives the failure informing signal, the main controller transmits an exchange informing signal for informing the second host I/F part 11B that is not a source of transmitting the failure informing signal of exchanging the storing areas with the second host I/F part.

After that, when the second host I/F part 11B receives the exchange informing signal from the main controller 12, the second host I/F part 11B transmits the exchange informing signal to the second host 2B.

Then, when the control part 20B of the second host 2B receives the exchange informing signal through the communication part 21B, the control part 20B temporarily stops the input and output of the data between the semiconductor storage device 1A and the second host 2B to return an exchanging preparation completion signal to the semiconductor storage device 1A. Before the control part 20B returns the exchanging preparation completion signal to the semiconductor storage device, the control part 20B may display on the display part 24B information that the control part receives the exchange informing signal.

Then, when the second host I/F part 11B receives the exchanging preparation completion signal, the second host I/F part 11B transmits the exchanging preparation completion signal to the main controller 12.

Subsequently, when the exchanging preparation completion signal is inputted from the first host I/F part 11A, the main controller 12 rewrites the range information of the register 120 to exchange the storing areas allocated to the first and second host I/F parts 11A and 11B.

FIG. 4B shows one example of the range information obtained when the storing areas are changed. That is, in range information 120e, to the first host I/F part 11A, the second storing area is allocated, and to the second host I/F part 11B, the first storing area is allocated.

Then, the main controller 12 transmits an exchange completion signal for informing the second host 2B of the exchange of the storing areas through the second host I/F part 11B.

After that, when the control part 20B of the second host 2B receives the exchange completion signal through the communication part 21B, the control part 20B requests the semiconductor storage device 1A to output the data stored in the first storing area. Before the control part 20B requests the semiconductor storage device to output the data, the control part 20B may display on the display part 24B a screen for recognizing whether or not the data is requested to be outputted.

Then, when the second host I/F part 11B of the semiconductor storage device 1A receives a request for outputting the data from the second host 2B, the second host I/F part 11B transmits the request to the main controller 12.

Then, the main controller 12 requests the plurality of memory controllers 130 to read the data stored in the first storing area in accordance with the request.

Subsequently, when the memory controller 130 receives the request, the memory controller 130 reads the data stored in the semiconductor memory 131 from the semiconductor memory 131 corresponding to the address of “0x000000” to the address “0x0fffff” of the first storing area. Then, the memory controller 130 transmits read data to the main controller 12 as the read data.

When the main controller 12 receives the read data, the main controller transmits the read data to the second host 2B through the second host I/F part 11B.

When the control part 20B of the second host 2B receives the read data through the communication part 21B, the control part stores the received data in the storing part 22B.

### Third Embodiment

Now, a storage system according to a third embodiment of the present invention will be described below. As compared with the storage system 100A according to the second embodiment, in the storage system according to this embodiment, an operation when storing areas are exchanged is changed. Namely, when control parts 20A and 20B operate in accordance with area setting programs 220 to display on display parts 24A and 24B screens for exchanging and changing the storing areas and input an instruction for exchanging range information by input parts 23A and 23B, first and second hosts 2A and 2B according to the third embodiment change the range information of a semiconductor storage 1A. Since other structures of the storage system according to the third embodiment are the same as those of the storage system 100A of the second embodiment, an explanation thereof will be omitted.

### (Operation of Third Embodiment)

Now, one example of an operation of the storage system according to the third embodiment will be described below. Firstly, when a user instructs to activate the area setting program 220 by the input part 23A of the first host 2A, the control part 20A receives an instruction for activating the program sent from the input part 23A to activate the area setting program 220. The instruction from the user may be received by the input part 23B of the second host 2B and the control part 20B may activate the area setting program 220.

Now, the control part 20A operates in accordance with the activated area setting program 220 to display on the display part 24A the screen for exchanging the storing areas.

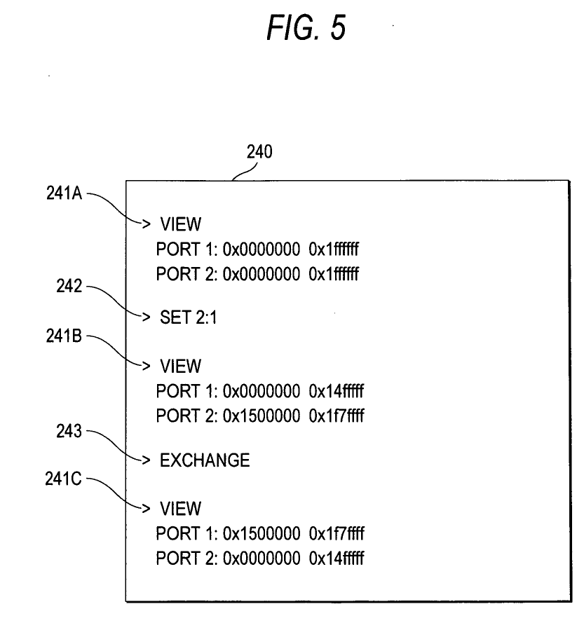

FIG. 5 shows one example of an area setting screen displayed on the display part 24A of the first host 2A. This area setting screen 240 serves as a command prompt for receiving an instruction (command) from the user. That is, when the control part 20A receives the command inputted by the input part 23A, the control part interprets the command to access the range information stored in a register 120 of the semiconductor storage device 1A through a communication part 21A, execute the command and display the executed result on the area setting screen 240.

Initially, when the user inputs “VIEW” as a display command 241A for displaying the range information, the control part 20A accesses the range information of the register 120, read the range information stored in the register 120 and display the result. Here, to first and second host I/F parts 11A and 11B, addresses of “0x0000000” to “0x1ffffff” are allocated as duplicated storing areas.

Then, when the user inputs “Set 2:1” as a setting command 242 for change the allocation of the storing areas, the control part 20A accesses the range information of the register 120 to rewrite the range information so that the ratio of the storage capacity of the storing area of the first host I/F part 11A to the storing area of the second host I/F part 11B is 2:1. Then, when the user inputs a display command 241B, the control part 20A accesses rewritten range information to display on the area setting screen 240 contents showing that a storing area of addresses of “0x0000000” to “0x14fffff” is allocated to the first host I/F part 11A and a storing area of addresses “0x1500000” to “0x1f7ffff” is allocated to the second host I/F part 11B.

Then, when the user inputs “Exchange” as an exchange command 243 for exchanging the storing areas, the control part 20A accesses the range information of the register 120 to rewrite the range information so that the storing areas of the first and second host I/F parts 11A and 11B are exchanged. Then, when the user inputs a display command 241C, the control part 20A accesses the exchanged range information to display on the area setting screen 240 contents showing that a storing area of addresses of “0x1500000” to “0x1f7ffff” is allocated to the first host I/F part 11A and a storing area of addresses “0x0000000” to “0x14fffff” is allocated to the second host I/F part 11B.

### Fourth Embodiment

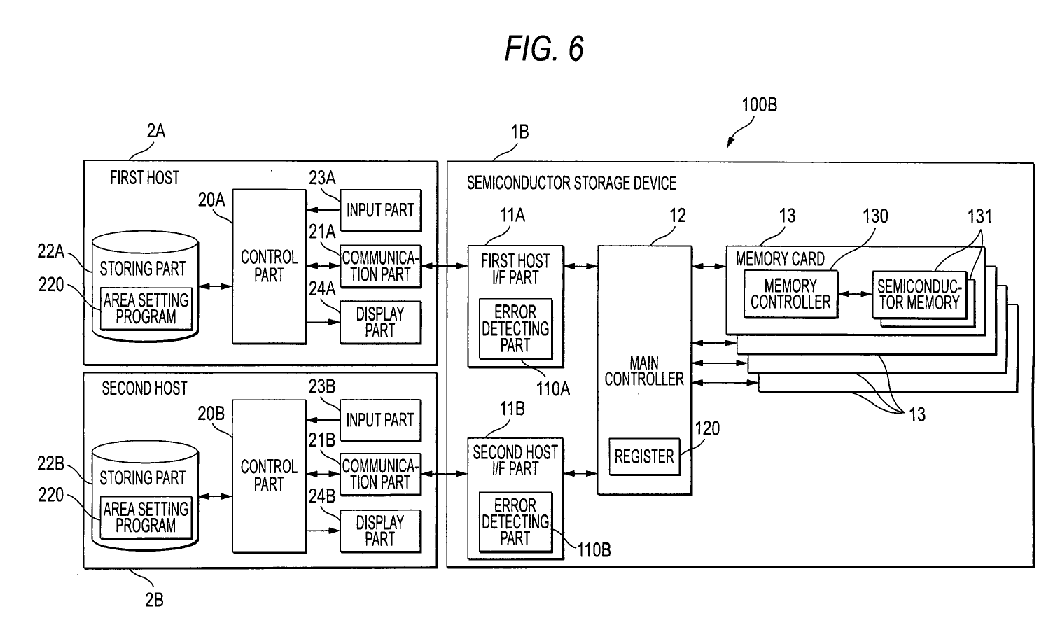

FIG. 6 is a block diagram showing a schematic structural example of a storage system according to a fourth embodiment of the present invention. As compared with the semiconductor storage device 1A according to the second embodiment, a semiconductor storage device 1B forming this storage system 100B further includes, in first and second host I/F parts 11A and 11B, error detecting parts 110A and 110B for detecting whether or not a failure is generated in inputting and outputting data between first and second hosts 2A and 2B and the semiconductor storage device 1B. Since other structures of the storage system 100B are the same as those of the storage system 100A according to the second embodiment, an explanation thereof will be omitted.

The error detecting parts 110A and 110B detect that the failure of hardware is generated in inputting and outputting the data between the first and second host I/F parts 11A and 11B and communication parts 21A and 21B. The failure of the hardware may be detected by an error correction code of, for instance, a humming code system, a read Solomon code system or the like, or an error rate showing the detecting frequency of detected failures. Further, the failure of the hardware may be detected by a monitor circuit for monitoring an abnormality of a power source, an abnormality of temperature, etc. Further, the detection of the failure may be carried out by combining them and is not limited thereto. Then, when the error detecting parts 110A and 110B detect the failure of the hardware, the error detecting parts transmit information that the failure of the hardware is detected to a main controller 12 as a failure informing signal.

Now, one example of an operation of the storage system 100B according to the fourth embodiment will be described below. Firstly, when the first host 2A requests the semiconductor storage device 1B to write the data, a control part 20A of the first host 2A transmits writing data and the writing address of the writing data to the semiconductor storage device 1B. Here, a first storing area is allocated to the first host I/F part 11A and a second storing area is allocated to the second host I/F part 11B like the second embodiment.

Then, when the first host I/F part 11A of the semiconductor storage device 1B receives the writing data, the error detecting part 110A provided in the first host I/F part 11A recognizes whether or not the failure of the hardware is generated in inputting the writing data.

Then, when the error detecting part 110A does not detect the failure of the hardware in inputting the writing data, the first host I/F part transmits the writing data to the main controller 12. Then, the main controller 12 writes the writing data in a semiconductor memory 131 corresponding to the writing address through a memory controller 130.

Further, when the error detecting part 110A detects the failure of the hardware in inputting the writing data, the error detecting part 110A transmits the failure informing signal to the main controller 12.

After that, when the main controller 12 receives the failure informing signal from the error detecting part 110A, the main controller 12 transmits an exchange informing signal for informing of exchanging the storing areas to the second host 2B through the second host I/F part 11B that is not a source of transmitting the failure informing signal.

Subsequently, when a control part 20B of the second host 2B receives the exchange informing signal, the control part 20B temporarily stops the input and output of the data relative to the semiconductor storage device 1B to send an exchanging preparation completion signal to the semiconductor storage device 1B.

Then, when the main controller 12 of the semiconductor storage device 1B receives the exchanging preparation completion signal through the first host I/F part 11A, the main controller rewrites range information of a register 120 to exchange the storing areas allocated to the first and second host I/F parts 11A and 11B and transmits an exchange completion signal for informing the second host 2B of exchanging the storing areas to the second host 2B through the second host I/F part 11B.

Then, when the second host 2B receives the exchange completion signal through the communication part 21B, the control part 20B requests the semiconductor storage device 1B to output the data stored in the first storing area like the second embodiment.

After that, the semiconductor storage device 1B reads the data stored in the first storing area through the memory controller 130 in accordance with the request and supplies read data to the second host 2B as the read data.

The control part 20B of the second host 2B receives the read data through the communication part 21B and stores the received read data in a storing part 22B.

### Fifth Embodiment

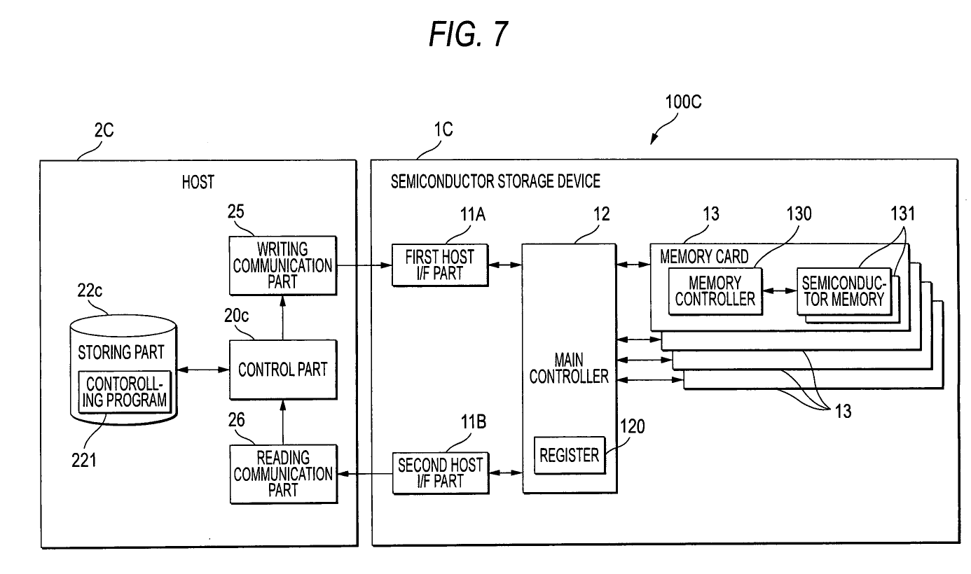

FIG. 7 is a block diagram showing a schematic structural example of a storage system according to a fifth embodiment. This storage system 100C includes one host 2C for carrying out a first-in and first-out of data that is connected to a semiconductor storage device 1C according to any one of the second to fourth embodiments.

The host 2C includes two communication parts of a writing communication part 25 for writing data and a reading communication part 26 for reading the data. The communication parts are respectively connected to first and second host I/F parts 11A and 11B of the semiconductor storage device 1C. The writing communication part 25 and the reading communication part 26 may be the two communication parts 21 provided in the second embodiment.

A control part 20C operates in accordance with a control program 221 stored in a storing part 22C to function as a data processing unit for processing the data and generating various kinds of data such as intermediate data or processed data during processing the data and a data control unit for controlling the first-in and first-out of the various kinds of data generated by the data processing unit by using the storing area of the semiconductor storage device 1C as an FIFO (First In First Out.

### (Operation of Fifth Embodiment)

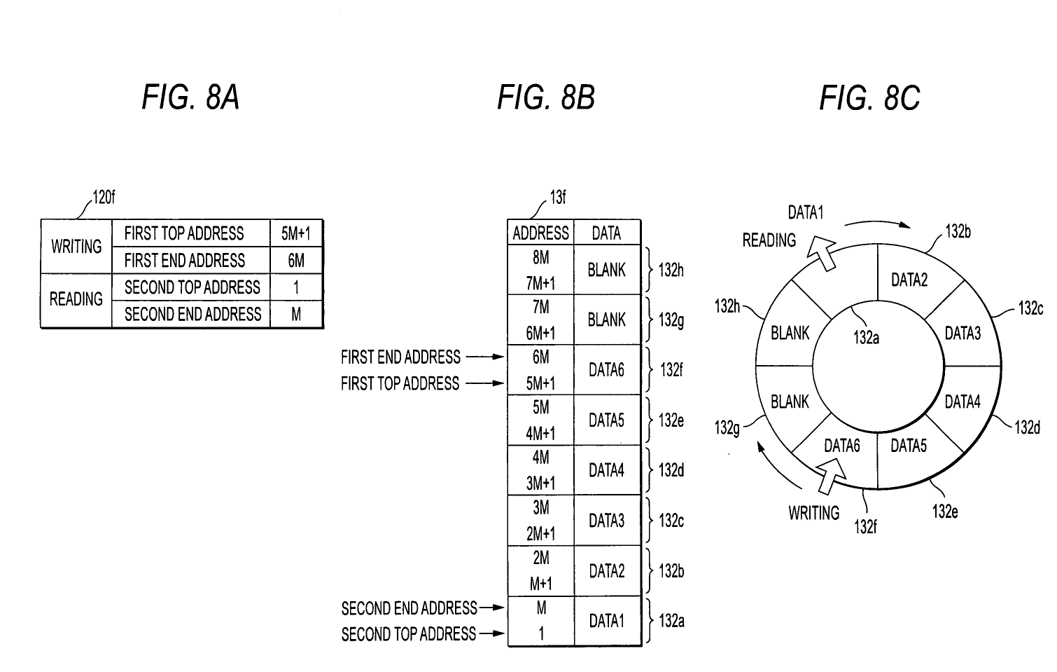

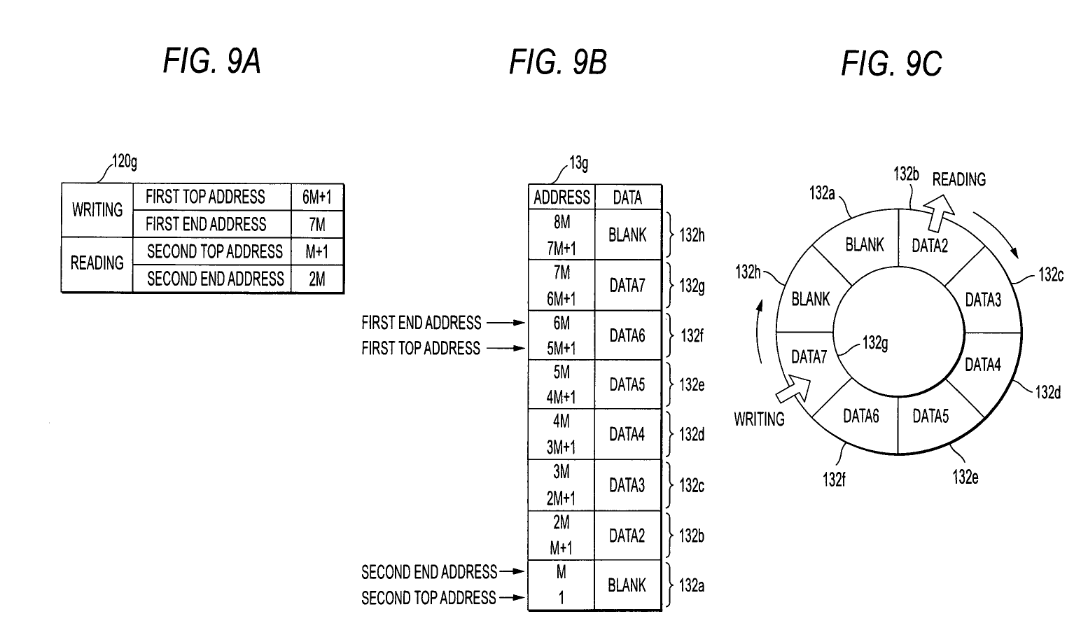

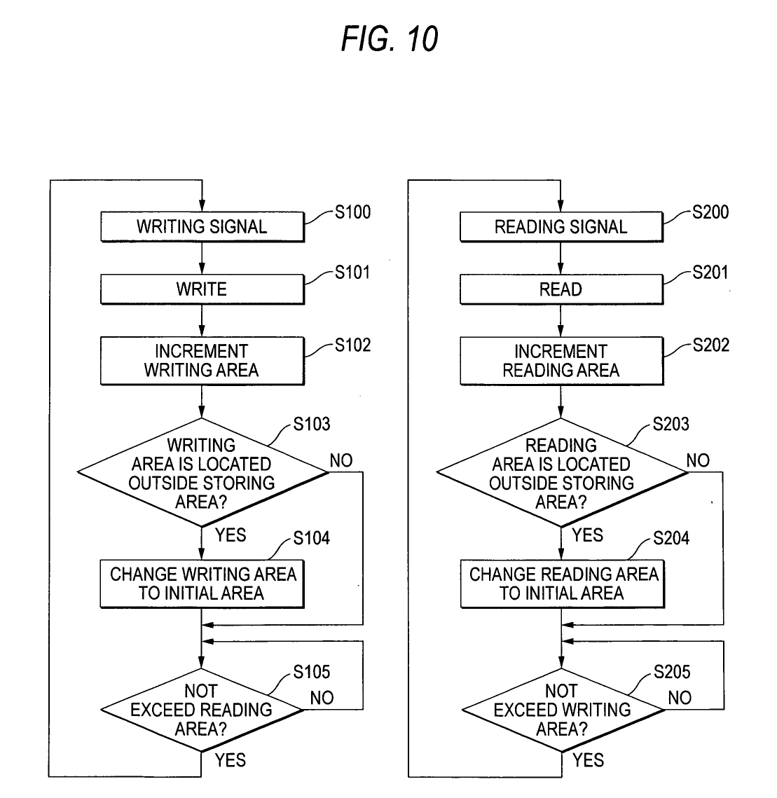

Now, one example of an operation of the storage system 100C according to the fifth embodiment will be described in accordance with a flowchart shown in FIG. 10 by using FIGS. 8 and 9. Firstly, it is assumed that the control part 20C of the host 2C processes the data by the data processing unit to generate the intermediate data at that time. Then, the data processing unit transmits the intermediate data to the data control unit as writing data.

Then, when the data control unit receives the writing data from the data processing unit, the data control unit transmits a writing signal and the writing data to the semiconductor storage device 1C through the writing communication part 25 (S100).

After that, when a main controller 12 of the semiconductor storage device 1C receives the writing signal and the writing data through the first host I/F part 11A, the main controller 12 stores the writing data in a memory card 13 in accordance with range information stored in a register 120 (S101).

Here, FIG. 8A shows the range information stored in the register 120. In this range information 120f, “5M+1” is stored in a first top address corresponding to the first host I/F part 11A and “6M” is stored in a first end address. Accordingly, the main controller 12 stores the writing data in a sixth storing area 132f as one of divided storing areas obtained by dividing a storing area 13f shown in FIG. 8B into eight parts. In the first to eighth storing areas 132a to 132h in FIG. 8B, respectively separate data can be stored.

Then, the data control unit of the host 2C increments a writing area corresponding to the first host I/F part 11A (S101). For instance, as shown in FIG. 8A, when the top address “5M+1” and the end address “6M” are stored in the range information allocated to the first host I/F part 11A, the data control unit transmits a control signal (a timing signal) to the semiconductor storage device 1C through the writing communication part 25 so that the range information is rewritten to a top address “6M+1” and an end address “7M” obtained by adding a storage capacity M of the divided storing area to these addresses, that is, a seventh storing area 132g.

Then, when the main controller 12 receives the control signal through the first host I/F part 11A, the main controller 12 rewrites the first top address to “6M+1” and the first end address to “7M”. Here, FIG. 9A shows rewritten range information 120g. The writing signal and the control signal may be transmitted at the same time or one signal may be commonly used as both the signals.

Subsequently, the data control unit decides whether or not the incremented writing area is outside the storing area (S103). Namely, as shown in FIG. 8C, when the storing area 13f is viewed in the form of a ring so that the first storing area 132a is arranged subsequently to the eighth storing area 132h, if the writing area before the increment is the eighth storing area 132h, a writing area obtained by incrementing the eighth area 132h is decided to be located outside the storing area.

Then, when the data control unit decides that the incremented writing area is located outside the storing area (S103: Yes), the data control unit transmits the control signal to the semiconductor storage device 1C like the step S101 so that the top address of the range information is rewritten to “1” and the end address is rewritten to “M” to return the writing area to an initial area, that is, the first storing area 132a (S104). Then, when the main controller 12 receives the control signal, the main controller rewrites the range information corresponding to the first host I/F part 11A to an address showing the initial area.

In the step S103, when the data control unit decides that the writing area is not located outside the storing area (S103: No), the data control unit does not return the writing area to the initial area and advances to a next step.

Then, the data control unit decides whether or not the writing area does not exceed a reading area (S105). That is, when the storing area 13f is viewed in the form of a ring, the data control unit recognizes whether or not the writing area exceeds the reading area so that the writing data is not overwritten on the divided storing area from which the data is not read yet. For instance, in the range information, “5M+1” is stored in the top address of a next writing area and “6M” is stored in an end address and “5M+1” is also stored in the top address of a reading area and “6M” is also stored in an end address, the data control unit decides that the writing area exceeds the reading are.

Then, when the writing area does not exceed the reading area (S105: Yes), the procedure returns to the step S100 and the data control unit waits until a next writing signal is inputted from the data processing unit.

After that, when the data control unit receives a next writing request from the data processing unit, the data control unit transmits a next writing signal and writing data to the semiconductor storage device 1C as described above (S100). Then, when the main controller 12 receives the writing signal and the writing data, the main controller stores the writing data in the seventh storing area 132g in accordance with the range information shown in FIG. 9A.

In the step S105, when the writing area exceeds the reading area (S105: No), the procedure does not return to the step S100 and the data control unit waits until the reading area is incremented.

On the other hand, it is assumed that the control part 20C of the host 2C requests the semiconductor storage device 1C to read the intermediate data stored in the semiconductor storage device in order to obtain data to be processed by the data processing unit. Then, the data processing unit transmits a reading request to the data control unit.

Then, when the data control unit receives the reading request from the data processing unit, the data control unit transmits a reading signal to the semiconductor storage device 1C through the reading communication part 26 (S200). The data control unit may transmit the writing signal and the reading signal at the same time or transmit the signals respectively at different timing. Further, the data control unit may continuously transmit the writing signals, or may continuously transmit the reading signals.

Subsequently, when the main controller 12 of the semiconductor storage device 1C receives the reading signal through the second host I/F part 11B, the main controller 12 reads the data from the memory card 13 corresponding to the divided storing area allocated to the second host I/F part 11B in accordance with the range information (S201).

Here, as shown in FIG. 8A, in the range information of the second host I/F part 11B, a top address “1” and an end address “M” are stored, the data is read from a storing area designated by these addresses, that is, the first storing area 132a shown in FIG. 8B.

Then, the main controller 12 transmits the read data to the host 2C through the host I/F 11B as the read data.

Then, when the data control unit of the host 2C receives the read data, the data control unit sends the read data to the data processing unit.

After that, the data control unit increments the reading area corresponding to the second host I/F part 11B as in the step S102 (S202) and decides whether or not the incremented reading area is located outside a range of the storing area (S203).

Then, when the data control unit decides that the incremented reading area is located outside the range of the storing area (S203: Yes), the data control unit returns the reading area to an initial area (S204).

In the step S203, when the data control unit decides that the reading area is not located outside the range of the storing area (S203: No), the data control unit does not return the reading area to the initial area to advance to a next step.

Then, the data control unit decides whether or not the reading area exceeds the writing area as in the step 105 (S205). When the reading area does not exceed the writing area (S205: Yes), the procedure returns to the step S200 and the data control unit waits until a next reading signal is inputted from the data processing unit.

After that, when the data control unit receives a next reading request from the data processing unit, the data control unit transmits a next reading signal to the semiconductor storage device 1C as described above (S200). Then, when the main controller 12 receives the reading signal, the main controller 12 reads read data from a second storing area 132b in accordance with the range information 120g shown in FIG. 9A and transmits the read data to the host 2C.

In the step S205, when the reading area exceeds the writing area (S205: No), the procedure does not return to the step S200 and the data control unit waits until the writing area is incremented.

### Sixth Embodiment

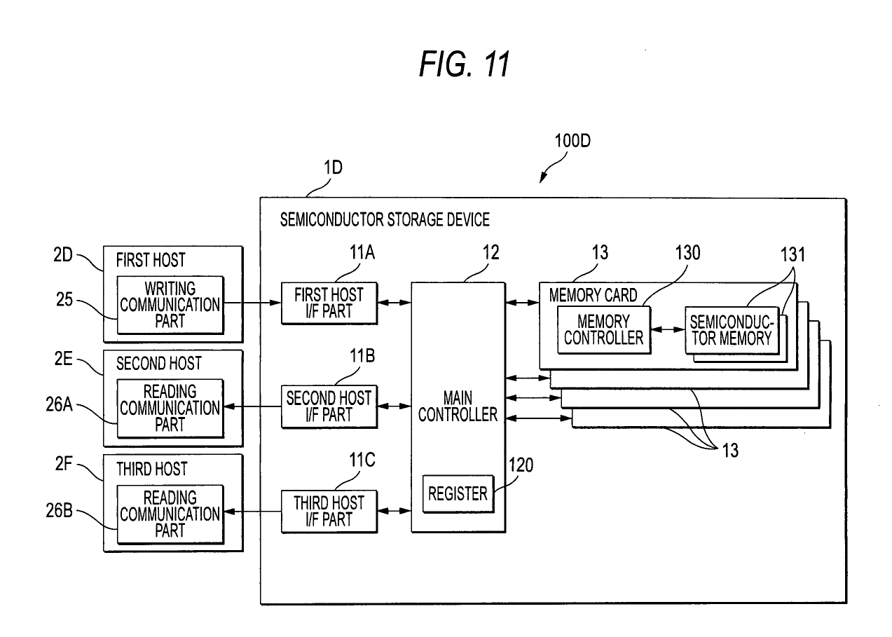

FIG. 11 is a block diagram showing a schematic structural example of a storage system according to a sixth embodiment of the present invention. This storage system 100D includes a semiconductor storage device 1D having first to third host I/F parts 11A to 11C to which three hosts 2D to 2F are respectively connected.

The first host 2D is provided with a writing communication part 25 for writing data in the semiconductor storage device 1D. The writing communication part 25 is connected to the first host I/F part 11A of the semiconductor storage device 1D. The second and third hosts 2E and 2F are respectively provided with reading communication parts 26A and 26B and these communication parts are respectively connected to the second and third host I/F parts 11B and 11C of the semiconductor storage device 1D. Since other structures of the storage system 100D are the same as those of the storage system 100C of the fifth embodiment, an explanation thereof will be omitted.

### (Operation of Sixth Embodiment)

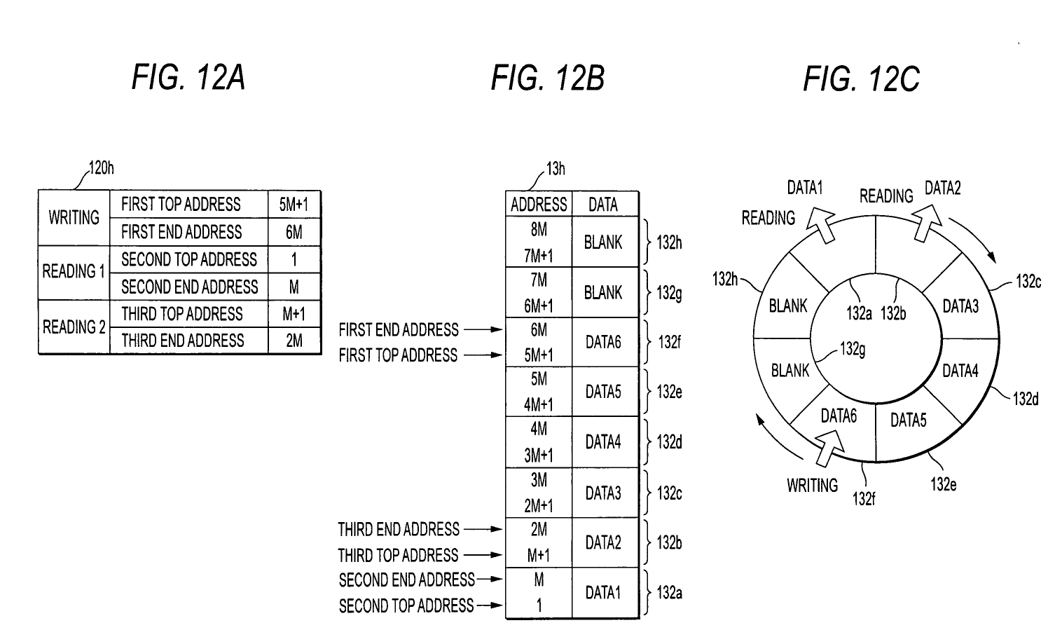

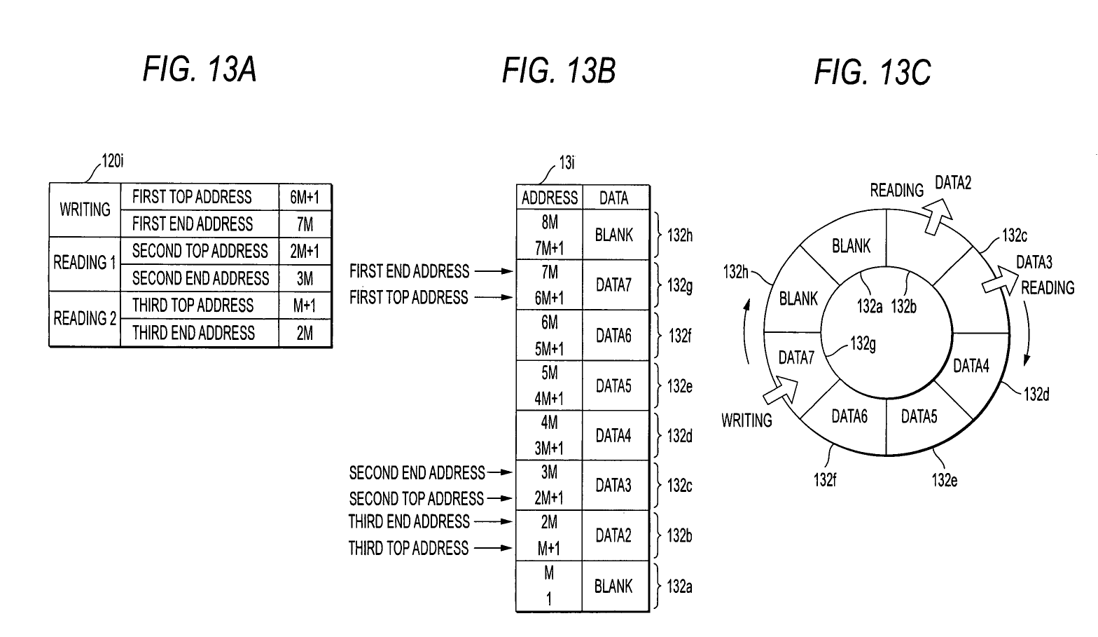

Now, one example of an operation of the storage system 100D according to the sixth embodiment will be described by referring to FIGS. 12 and 13. Initially, the first host 2D transmits writing data generated by a generating unit to the semiconductor storage device 1D together with a writing signal through the writing communication part 25 like the fifth embodiment.

Then, when a main controller 12 of the semiconductor storage device 1D receives the writing signal and the writing data through the first host I/F part 11A, the main controller stores the writing data in a memory card 13 in accordance with range information stored in a register 120.

Here, FIG. 12A shows the range information stored in the register 120. In this range information 120h, a sixth storing area 132f is allocated to the first host I/F part 11A. The main controller 12 stores the writing data in the sixth storing area 132f shown in FIG. 12B.

Then, when the first host 2D transmits a next writing signal and writing data to the semiconductor storage device 1D, the first host 2D sends a control signal for rewriting the range information so that the writing data is written in a divided storing area subsequent to a divided storing area in which the data is written the last time. When the divided storing area in which the data is written the last time is an eighth storing area 132h, the first host 2D sends a control signal for rewriting the range information so that the next divided storing area is a first storing area 132a. Further, when the data is written in the next divided storing area, the first host 2D holds the transmission of the writing data until the second and third hosts 2E and 2F read the data.

Here, FIG. 13A shows rewritten range information. In this range information 120i, a seventh storing area 132g is allocated to the first host I/F part 11A. The main controller 12 stores the next writing data in the seventh storing area 132g shown in FIG. 13B.

On the other hand, it is assumed that the second host 2E of the second and third hosts 2E and 2F transmits a reading signal of the data to the semiconductor storage device 1D through the reading communication part 26A. When the third host 2F sends the reading signal to the semiconductor storage device, the same operation is also carried out.

Then, when the main controller 12 of the semiconductor storage device 1D receives the reading signal through the second host I/F part 11B, the main controller reads the data from the memory card 13 corresponding to a divided storing area allocated to the second host I/F part 11B.

Here, in the range information 120h shown in FIG. 12A, the first storing area 132a is allocated to the second host I/F part 11B. The main controller 12 reads the data from the first storing area 132a.

Then, the main controller 12 transmits the read data to the second host 2E as the read data through the second host I/F 11B. Then, the second host 2E receives the read data through the reading communication part 26A.

After that, when the second host 2E transmits a next reading signal to the semiconductor storage device 1D, the second host 2E sends to the semiconductor storage device 1D a control signal for rewriting the range information so that the data is read from a divided storing area subsequent to the divided storing area in which the data is read the last time.

Further, when the divided storing area in which the data is read the last time is the eighth storing area 132h, the second host 2E sends a control signal for rewriting the range information so that the next divided storing area is the first storing area 132a. Further, when the data is not written in the next divided storing area, the second host 2E holds the transmission of the reading signal until the first host 2D writes the data. Further, the second host 2E controls a reading area so that the next divided storing area is not duplicated between both the hosts.

Here, in the range information 120i shown in FIG. 13A, a third storing area 132c is allocated to the second host I/F part 11B and the main controller 12 reads next reading data from the third storing area 132c shown in FIG. 13B.

### Seventh Embodiment

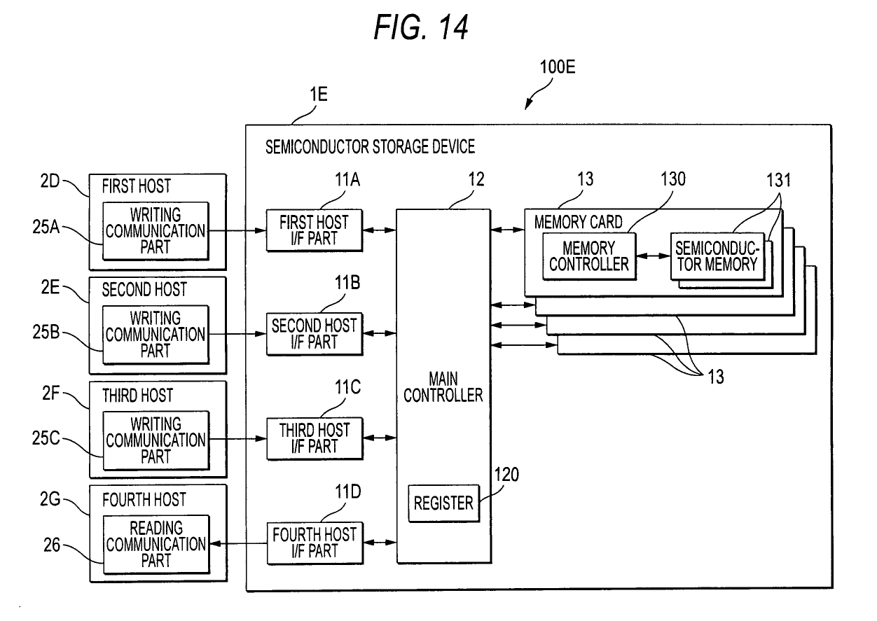

FIG. 14 is a block diagram showing a schematic structural example of a storage system according to a seventh embodiment of the present invention. This storage system 100E includes a semiconductor storage device 1E having first to fourth host I/F parts 11A to 11D to which a total of four hosts including first to third hosts 2D to 2F having writing communication parts 25A to 25C and a fourth host 2G having a reading communication part 26 are respectively connected. Since other structures of the storage system 100E are the same as those of the storage system 100D of the sixth embodiment, an explanation thereof will be omitted.

### (Operation of Seventh Embodiment)

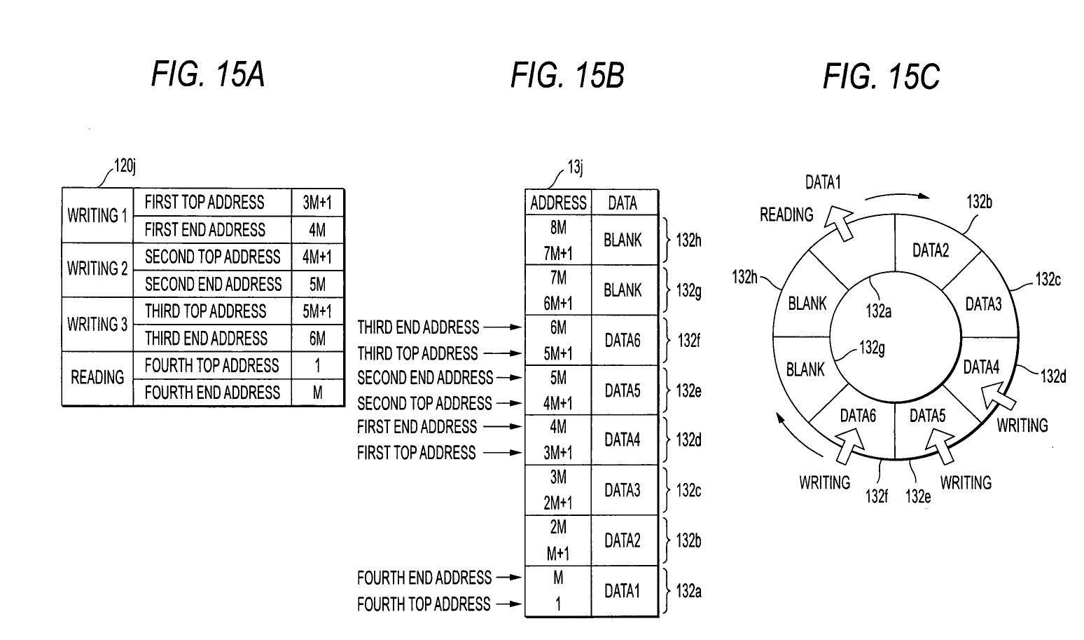

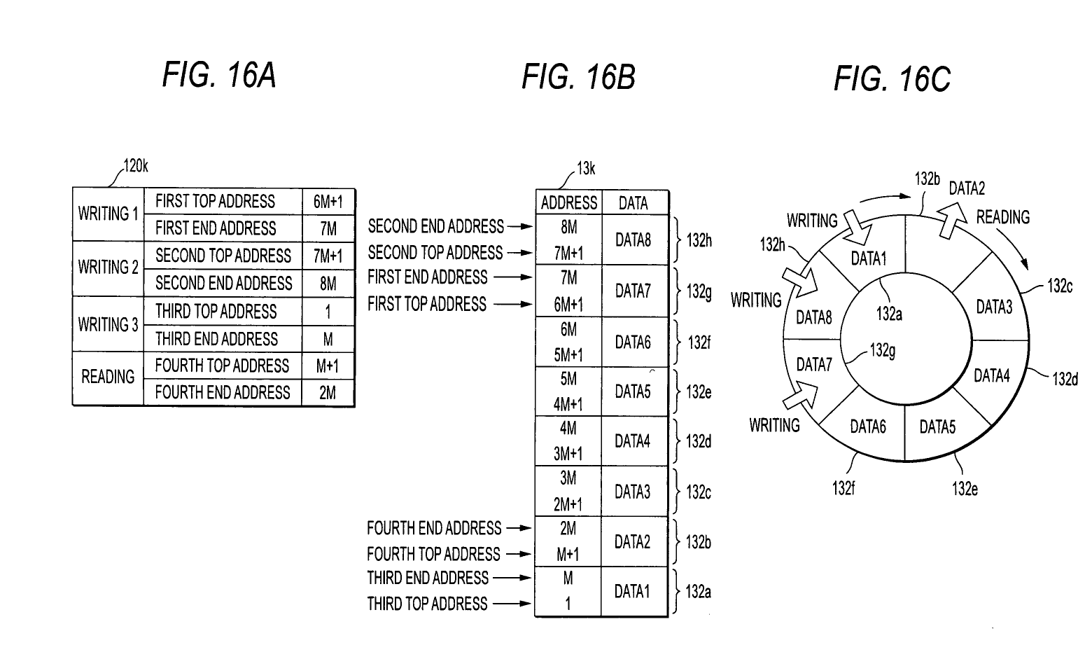

Now, one example of an operation of the storage system 100E according to the seventh embodiment will be described by referring to FIGS. 15 and 16. Firstly, the first to third hosts 2D to 2F transmit writing data to the semiconductor storage device 1E together with a writing signal through the writing communication parts 25A to 25C.

Then, when a main controller 12 of the semiconductor storage device 1E receives the writing signal and the writing data through the first to third host I/F parts 11A to 11C, the main controller stores the writing data in a memory card 13 in accordance with range information stored in a register 120. That is, the main controller 12 stores the writing data respectively in fourth to sixth storing areas 132d to 132f shown in FIG. 15B in accordance with range information 120j shown in FIG. 15A.

Then, the first to third hosts 2D to 2F send to the semiconductor storage device 1E a control signal that rewrites a writing area to a divided storing area subsequent to a divided storing area in which the data is written the last time like the operation of the sixth embodiment, so that when the divided storing area in which the data is written the last time is an eighth storing area 132h, a first storing area 132a is determined to be a writing area. Further, when the data is written in the next divided storing area, the first to third hosts 2D to 2F wait until the fourth host 2G reads the data. Further, the first to third hosts 2D to 2F control the writing areas so that the next divided storing areas are not duplicated between the three hosts.

Here, FIG. 16A shows rewritten range information. In this range information 120k, the writing areas of the first to third host I/F parts 11A to 11C are respectively allocated to a seventh storing area 132g, the eighth storing area 132h and the first storing area 132a. Accordingly, the main controller 12 stores the next writing data supplied from the first to third hosts 2D to 2F respectively in the seventh storing area 132g, the eighth storing area 132h and the first storing area 132a shown in FIG. 16B.

On the other hand, when the fourth host 2G transmits a reading signal of the data to the semiconductor storage device 1E through the reading communication part 26, the data is read in accordance with the range information like the operation of the sixth embodiment.

### Eighth Embodiment

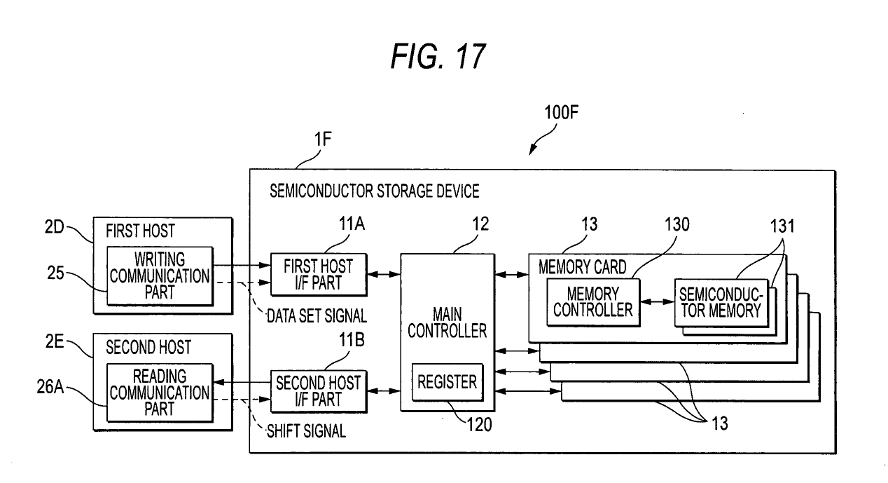

FIG. 17 is a block diagram showing a schematic structural example of a storage system according to an eighth embodiment of the present invention. This storage system 100F includes a semiconductor storage device 1F having first and second host I/F parts 11A and 11B to which a first host 2D having a writing communication part 25 and a second host 2E having a reading communication part 26 are respectively connected. The number of the hosts is not limited to two and may be one or three or more.

### (Operation of Eighth Embodiment)

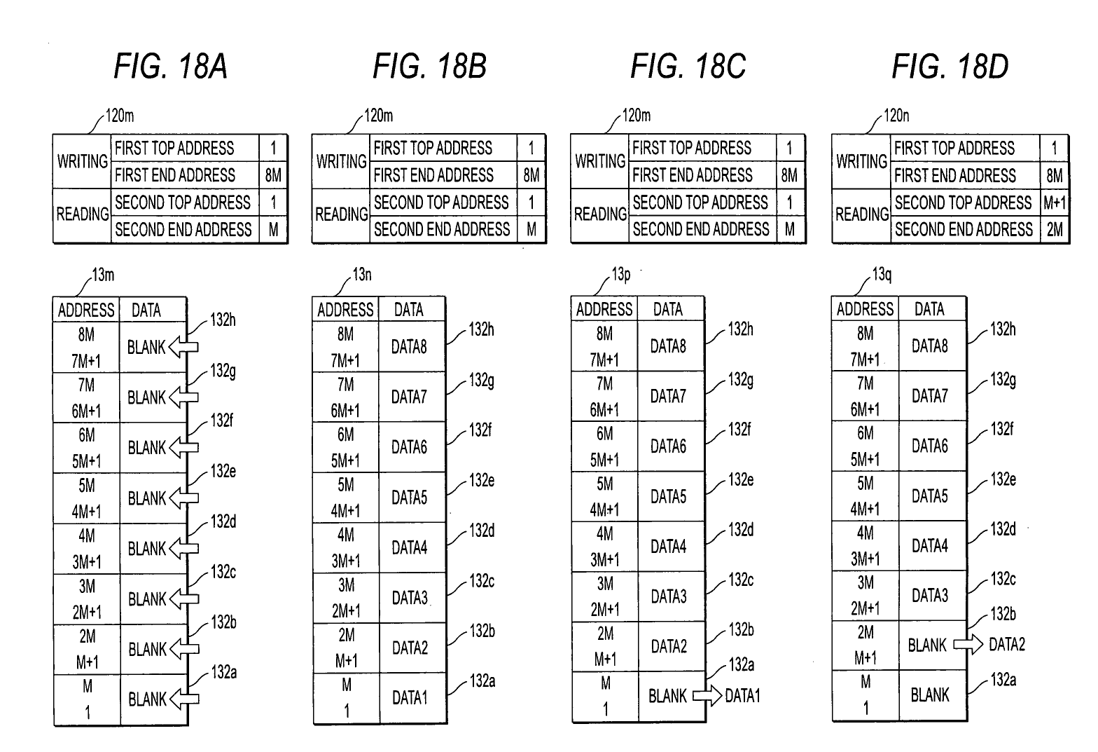

Now, one example of an operation of the storage system 100F according to the eighth embodiment will be described by referring to FIG. 18. Initially, it is assumed that the first host 2D transmits writing data to the semiconductor storage device 1F together with a writing request (a data set signal) through the writing communication part 25.

Then, when a main controller 12 of the semiconductor storage device 1F receives the writing data through the first host I/F part 11A, the main controller stores the writing data in an entire storing area composed of a plurality of memory cards 13 in accordance with range information.

Here, FIG. 18A shows the range information and the storing area. In this range information 120m, the entire storing area is allocated to the first host I/F part 11A. The main controller 12 stores the writing data composed of data 1 to data 8 in the entire storing area as shown in FIG. 18B.

Then, the second host 2E sends a reading signal of the data to the semiconductor storage device 1F through the reading communication part 26.

Then, when the main controller 12 of the semiconductor storage device 1F receives the reading signal through the second host IF part 11B, the main controller reads the data from the memory card 13 corresponding to a divided storing area allocated to the second host I/F part 11B. That is, in the range information 120m, since a first storing area 132a is allocated to the second host I/F part 11B, the main controller 12 reads the data from the first storing area 132a.

After that, the main controller 12 transmits the read data to the second host 2E through the second host I/F part 11B as the read data. Then, second host 2E receives the read data through the reading communication part 26.

Then, the second host 2E supplies a shift signal for rewriting the range information so as to read the data from a divided storing area subsequent to a divided storing area in which the data is read the last time. Then, when the main controller 12 receives the shift signal, the main controller rewrites the range information corresponding to the second host I/F part 11B.

Here, FIG. 18D shows rewritten range information. In this range information 120n, as a next divided storing area of the first storing area 132a, a second storing area 132b is allocated to the second host I/F part 11B.

Then, when the main controller 12 of the semiconductor storage device 1F receives a next reading signal through the second host I/F part 11B, the main controller reads the data from the second storing area 132b in accordance with the range information 120n as shown in FIG. 18D. The shift signal and the reading signal may be transmitted at the same time or one signal may be commonly used as both the signals.

Then, when the main controller 12 sequentially reads the data to an eighth storing area 132h, the main controller rewrites a next reading area to the first storing area 132a. Then, the second host 2E waits until the first host 2D writes next data in all the storing area.

Then, when the first host 2D writes the next data in all the storing area, the second host 2E similarly sequentially reads the data from the first storing area 132a.

### Other Embodiments

The present invention is not limited to the above-described embodiments and various modifications may be made within a range without departing from the gist of the present invention. For instance, in the second and fourth embodiments, when the main controller 12 of the semiconductor storage device receives the exchanging preparation completion signal from the first and second hosts 2A and 2B, the main controller 12 rewrites the range information of the register 120 so that the storing areas allocated to the first and second host I/F parts 11A and 11B are exchanged. However, the control parts 20A and 20B of the first and second hosts 2A and 2B may access the range information stored in the register 120 to rewrite the range information so that the storing areas are exchanged.

Further, components of the embodiments respectively may be arbitrarily combined together within a range without departing the gist of the present invention.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A storage system comprising:
a plurality of data input and output parts through which data is inputted and outputted;
a data storing part that stores the data inputted and outputted through the plurality of data input and output parts;
a range information storing part that stores range information showing ranges of a storing area of the data storing part which are respectively allocated to the plurality of data input and output parts;
a first control part controlling the data storing part to read and write the data in accordance with the range information stored in the range information storing part, and that rewrites the range information stored by the range information storing part to predetermined range information in a case where a prescribed signal is inputted from the data input and output part; and
a plurality of second control parts that are provided correspondingly to the plurality of data input and output parts to input and output the data between the plurality of data input and output parts and the second control parts, and that input the prescribed signal to the data input and output parts in a prescribed case.

2. The storage system as claimed in claim 1,
wherein,
in a case where the second control parts detect a failure in inputting and outputting the data to the data input and output parts, the second control parts input a failure informing signal as the prescribed signal, and
the first control part rewrites the range information so that the storing area allocated to the data input and output part is allocated to the data input and output part to which the failure informing signal is not inputted in a case where the failure informing signal is inputted from the data input and output parts.

3. The storage system as claimed in claim 1,
wherein
the data storing part includes a plurality of divided storing areas obtained by dividing the storing area into a plurality of parts, and
in a case where the second control parts input and output the data to the divided storing areas, the second control parts input a timing signal for controlling a first-in and first out of the data as the prescribed signal, and
in a case where the timing signal is inputted, the first control part rewrites the range information so that one divided storing area of the plurality of divided storing areas is allocated to the data input and output part and controls the divided storing area to read and write the data.

4. The storage system as claimed in claim 1,
wherein
the data storing part includes a plurality of divided storing areas obtained by dividing the storing area into a plurality of parts, and
in a case where the second control parts input and output data to the storing area, the second control parts input a data set signal for instructing to input and output the data and a shift signal for instructing to input and output divided data obtained by dividing the data into a plurality of parts as the prescribed signal, and
in a case where the data set signal is inputted, the first control part rewrites the range information so that the storing area is allocated to the data input and output part and controls the storing area to read and write the data, and
in a case where the signal is inputted, the first control part rewrites the range information so that the one divided storing area of the plurality of divided storing areas is allocated to the data input and output part and controls the divided storing area to read and write the divided data.

5. A storage device comprising:
a plurality of data input and output parts through which data is inputted and outputted;
a data storing part that stores the data inputted and outputted through the plurality of data input and output parts;
a range information storing part that stores range information showing ranges of a storing area of the data storing part which are respectively allocated to the plurality of data input and output parts; and
a control part that controls the data storing part to read and write the data in accordance with the range information stored in the range information storing part and rewrites the range information stored by the range information storing part to predetermined range information in a case where a prescribed signal is inputted from the data input and output part.
